(19) United States
(12) Patent Application Publication
(10) Pub. No.: US 2024/0129187 A1
(43) Pub. Date: Apr. 18, 2024

(54) ACCESS POINT DEVICE USAGE-BASED RECOMMENDATION

(71) Applicant: ARRIS Enterprises LLC, Suwanee, GA (US)

(72) Inventors: Krishna Prasad PANJE, Bengaluru (IN); Lakshmi ARUNKUMAR, Bengaluru (IN)

(21) Appl. No.: 18/376,938

(22) Filed: Oct. 5, 2023

Related U.S. Application Data
(60) Provisional application No. 63/415,372, filed on Oct. 12, 2022.

(51) Int. Cl. H04L 41/0816

(52) U.S. Cl. CPC H04L 41/0816

(57) ABSTRACT

One or more network metrics associated with one or more network devices of a network environment can be improved by analyzing these network metrics at a network resource. The network resource can compare the one or more network metrics collected over a period time to a corresponding threshold. Based on a comparison of the one or more network metrics, for example, an average of the one or more network metrics, to one or more corresponding thresholds, the network resource can determine one or more network configurations that can be sent to a user, a client device or both. The one or more network configurations can provide one or more recommendations for improving the network performance, for example, the one or more network metrics, such as by adding, removing, replacing or otherwise changing one or more existing network devices.

### BACKGROUND

Companies are increasingly providing Multiple Access Point (MAP) architecture or Home Network Controller (HNC) and/or mesh type of wireless fidelity (Wi-Fi) management, with multiple access point devices and/or extender access point devices within the network to improve Quality of Experience (QoE) of the user by offering extended coverage with seamless roaming. Generally, these network devices are included within a network environment without consideration for ongoing monitoring for to advise a user of improvements to a network environment. Thus, there is a need to provide users with alternatives to a current network configuration.

### SUMMARY

According to aspects of the present disclosure there are provided novel solutions for providing alternative network configurations based on current network metrics. A network environment can include multiple network devices including any of an access point device (APD), one or more extender access point devices (EAPD), any other network device, or any combination thereof. In today's environment, network devices are increasingly being improved or enhanced at a rate that makes it difficult for a user to determine when and/or if to replace existing network devices with other network devices. One of the key improvements that are generally made to network devices relates to data rate, hence throughput support. However, a user may not recognize when such an improvement needs to be made to make operation of the network environment more efficient or to increase quality of experience (QoE). As a user may be unaware of enhancements that could be made to the network environment by replacing existing network devices with other network devices that have improved technology or characteristics that better match the network environment, there is an underutilization of these other network devices. Thus, there is a need to provide a user with one or more configuration notifications for improving the network environment and overall QoE. For example, the one or more configuration notifications can comprise a recommendation to a user for improving one or more network metrics by replacing a current or existing network device with a different network device. According to one or more novel solutions, one or more network metrics, such as any of an uplink and/or downlink rate associated with a network device, client data consumption rate, or both, are analyzed, for example, averaged over a period of time, and compared to a threshold so as to determine one or more configuration notifications to provide to a user. The one or more configuration notifications can comprise information or a recommendation to assist the user in replacing one or more existing network devices with one or more other network devices so as to improve one or more network metrics for the network environment.

An aspect of the present disclosure provides a network resource for determining one or more configuration notifications. The network resource comprises a memory storing one or more computer-readable instructions and a processor configured to execute the one or more computer-readable instructions stored on the memory to cause the network resource to receive one or more network metrics associated with a network environment from a network device of the network environment, compare the one or more network metrics to a corresponding threshold, and send one or more configuration notifications to a client device based on the comparison.

In an aspect of the present disclosure, the processor is further configured to execute the one or more computer-readable instructions to cause the network resource to collect the one or more network metrics for a period of time, wherein the comparing the one or more network metrics comprises averaging the one or more network metrics collected for a period of time and comparing the average to the corresponding threshold.

In an aspect of the present disclosure, wherein at least one of the one or more network metrics comprise any of an uplink speed, a downlink speed, a client data consumption rate, or any combination thereof, and the one or more network metrics comprises one or more first network metrics associated with another network device and one or more second network metrics associated with the network device.

In an aspect of the present disclosure, the processor is further configured to execute the one or more computer-readable instructions to cause the network resource to store the one or more network metrics, the corresponding threshold, or both.

In an aspect of the present disclosure, wherein the one or more network configurations comprise a recommendation for any of replacing one or more existing or current network devices with one or more other network devices, adding one or more other network devices, removing one or more existing or current network devices, upgrading hardware, software, or both, or any combination thereof.

In an aspect of the present disclosure, the processor is further configured to execute the one or more computer-readable instructions to cause the network resource to determine one or more configuration notifications based on any of the comparison, one or more network devices associated with the one or more network metrics, a user account associated with the network environment, or any combination thereof.

In an aspect of the present disclosure, the client device is associated with a user account associated with the network environment.

An aspect of the present disclosure provides a method for a network resource for determining one or more configuration notifications. The method comprises receiving one or more network metrics associated with a network environment from a network device of the network environment, comparing the one or more network metrics to a corresponding threshold, and sending one or more configuration notifications to a client device based on the comparison.

In an aspect of the present disclosure, the method further comprising collecting the one or more network metrics for a period of time, wherein the comparing the one or more network metrics comprises averaging the one or more network metrics collected for a period of time and comparing the average to the corresponding threshold.

In an aspect of the present disclosure, the method such that at least one of the one or more network metrics comprises one or more first network metrics associated with another network device and one or more second network metrics associated with the network device, and the one or more network metrics comprise any of an uplink speed, a downlink speed, a client data consumption rate, or any combination thereof.

In an aspect of the present disclosure, the method further comprising storing the one or more network metrics, the corresponding threshold, or both.

In an aspect of the present disclosure, the method such that the one or more network configurations comprise a recommendation for any of replacing one or more existing or current network devices with one or more other network devices, adding one or more other network devices, removing one or more existing or current network devices, upgrading hardware, software, or both, or any combination thereof.

In an aspect of the present disclosure, the method such that determining one or more configuration notifications based on any of the comparison, one or more network devices associated with the one or more network metrics, a user account associated with the network environment, or any combination thereof.

In an aspect of the present disclosure, the method such that the client device is associated with a user account associated with the network environment.

An aspect of the present disclosure provides a non-transitory computer readable medium for a network resource. The program when executed by a processor of the network resource, causes the network resource to perform one or more operations including the steps of the methods described above.

Thus, according to various aspects of the present disclosure described herein, it is possible to provide a user associated with a client device one or more configuration notifications that are based on a comparison of one or more network metrics associated with one or more network devices of a network environment to one or more corresponding thresholds. In this way, a user can be informed of how to improve the network environment.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, client device, and extender access point device implemented in the network environment of FIG. 1, according to one or more aspects of the present disclosure;

FIG. 3 is a more detailed block diagram illustrating certain components of an exemplary network device implemented in of FIGS. 1-2, according to one or more aspects of the present disclosure;

FIG. 4 is a flow diagram illustrating providing one or more configuration notifications to a client device, according to one or more aspects of the present disclosure; and

FIG. 5 is a flow chart illustrating a method for providing one or more configuration notification to a client device, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

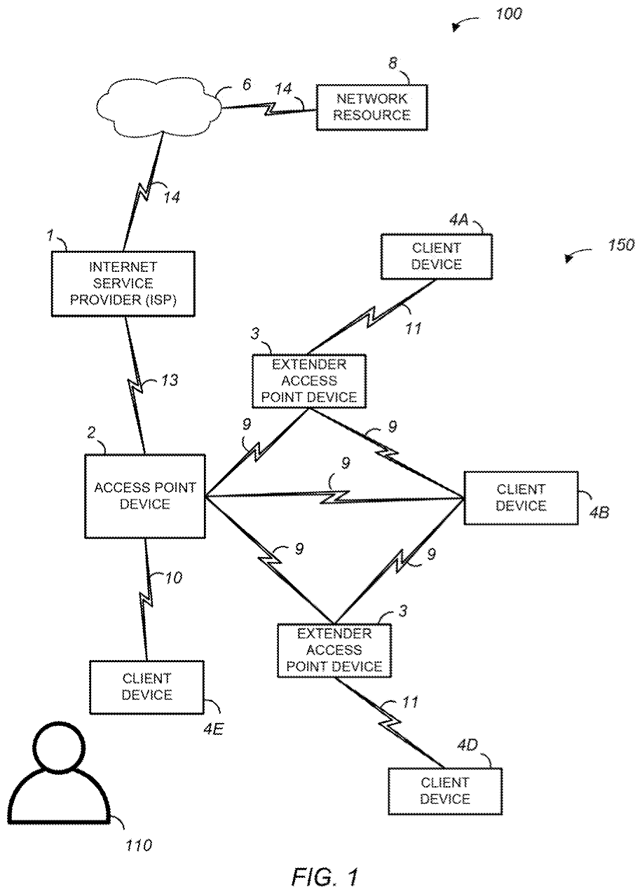

FIG. 1 is a schematic diagram of a network system 100, according to one or more example embodiments. It should be appreciated that various example embodiments of inventive concepts disclosed herein are not limited to specific numbers or combinations of devices, and there may be one or multiple of some of the aforementioned electronic apparatuses in the system, which may itself consist of multiple communication networks and various known or future developed wireless connectivity technologies, protocols, devices, and the like.

As shown in FIG. 1, the network system 100 comprises a network resource 8 connected to Internet 6 and an APD 2 connected to the Internet 6 via an Internet Service Provider (ISP) 1 and also connected to different network devices such as one or more wireless EAPDs 3, for example, a satellite APD 2, and one or more client devices 4A-4E, collectively referred to as client device(s) 4. The network environment 150 shown in FIG. 1 includes network devices (for example, an APD 2, an EAPD 3 and a client device 4) that may be connected in one or more wireless networks (for example, private, guest, iControl, backhaul network, or Internet of things (IoT) network) within the network environment 150. Additionally, there could be some overlap between network devices (for example, EAPDs 3 and client devices 4) in the different networks. That is, one or more network or wireless devices could be located in more than one network. For example, the EAPDs 3 could be located both in a private network for providing content and information to a client device 4 and also included in a backhaul network or an iControl network.

The ISP 1 of network system 100 can be for connecting the APD 2 to the Internet 6. The network resource 8 can be any type of network device and/or network repository that receives one or more network metrics from a network device within the network environment 150, for example, an APD 2 and determines one or more configuration notifications based on the one or more network metrics. The network resource 8 can comprise any of a cloud server, a website, a repository, a network service, any other network device capable of receiving and/or analyzing one or more network metrics, or any combination thereof. The connection 14 between the Internet 6 and the ISP 1 and between the Internet 6 and network resource 8 and the connection 13 between the ISP 1 and the APD 2 can be implemented using a wide area network (WAN), a virtual private network (VPN), metropolitan area networks (MANs), system area networks (SANs), a data over cable service interface specification (DOCSIS) network, a fiber optics network (for example, FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, 6G, etc. network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3r d Generation Partnership Project (3GPP) Long Term Evolution (LTE), 5G, or 6G protocols. It is also contemplated by the present disclosure that connection 13 is capable of providing connections between the APD 2 and a WAN, a LAN, a VPN, MANs, PANs, WLANs, SANs, a DOCSIS network, a fiber optics network (for example, FTTH, FTTX, or HFC), a PSDN, a global Telex network, or a 2G, 3G, 4G, 5G, or 6G network, for example.

The APD 2 can be, for example, an access point and/or a hardware electronic device that may be a combination modem and gateway that combines the functions of a modem, an access point (AP), and/or a router for providing content received from the ISP 1 to network devices (for example, one or more wireless EAPDs 3 and one or more client devices 4) in the network environment 150. It is also contemplated by the present disclosure that the APD 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The APD 2 may also be referred to as a residential gateway, a home network gateway, or a wireless access point (AP). The APD 2 can include a controller 102.

The connection 9 between the APD 2, the wireless EAPDs 3, and client devices 4 can be implemented using a wireless connection in accordance with any IEEE 802.11 Wi-Fi protocols, Bluetooth protocols, Bluetooth low energy (BLE), or other short range protocols that operate in accordance with a wireless technology standard for exchanging data over short distances using any licensed or unlicensed band such as the citizens broadband radio service (CBRS) band, 2.4 GHz band, 5 GHz band, 6 GHz band, or 60 GHz band. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of the connections 9 can carry information on any of one or more channels of a frequency band that are available for use.

The EAPDs 3 can be, for example, wireless hardware electronic devices such as access points, extenders, repeaters, etc. used to extend the wireless network by receiving the signals transmitted by the APD 2 and rebroadcasting the signals to, for example, client devices 4, which may out of range of the APD 2. The EAPDs 3 can also receive signals from the client devices 4 and rebroadcast the signals to the APD 2, or other client devices 4.

The connection 11 between the EAPDs 3 and the client devices 4 are implemented through a wireless connection that operates in accordance with any IEEE 802.11 Wi-Fi protocols, Bluetooth protocols, BLE, or other short range protocols that operate in accordance with a wireless technology standard for exchanging data over short distances using any licensed or unlicensed band such as the CBRS band, 2.4 GHz band, 5 GHz band, 6 GHz band, or 60 GHz band. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection. Any one or more connections 11 can carry information on any one or more channels 11A that are available for use.

The client devices 4 can be any type of network device that connects to an APD 2, an EAPD 3, or both, for example, hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the APD 2. Additionally, the client devices 4 can be a television (TV), an IP/QAM set-top box (STB) or a streaming media decoder (SMD) that is capable of decoding audio/video content, and playing over OTT or MSO provided content received through the APD 2. For example, a client device 4E can be a mobile phone associated with a user 110 and capable of receiving one or more configuration notifications from the APD 2 regarding the configuration of the network environment 150. In one or more embodiments, the client device 4E can initiate a configuration or onboarding of the APD 2.

The connection 10 between the APD 2 and the client device 4 is implemented through a wireless connection that operates in accordance with, but is not limited to, any IEEE 802.11 protocols. Additionally, the connection 10 between the APD 2 and the client device 4 can also be implemented through a WAN, a LAN, a VPN, MANs, PANs, WLANs, SANs, a DOC SIS network, a fiber optics network (for example, FTTH, FTTX, or HFC), a PSDN, a global Telex network, or a 2G, 3G, 4G, 5G, 6G, etc. network, for example. The connection 10 can also be implemented using a wireless connection in accordance with Bluetooth protocols, BLE, or other short range protocols that operate in accordance with a wireless technology standard for exchanging data over short distances using any licensed or unlicensed band such as the CBRS band, 2.4 GHz band, 5 GHz band, 6 GHz band, or 60 GHz band. One or more of the connections 10 can also be a wired Ethernet connection.

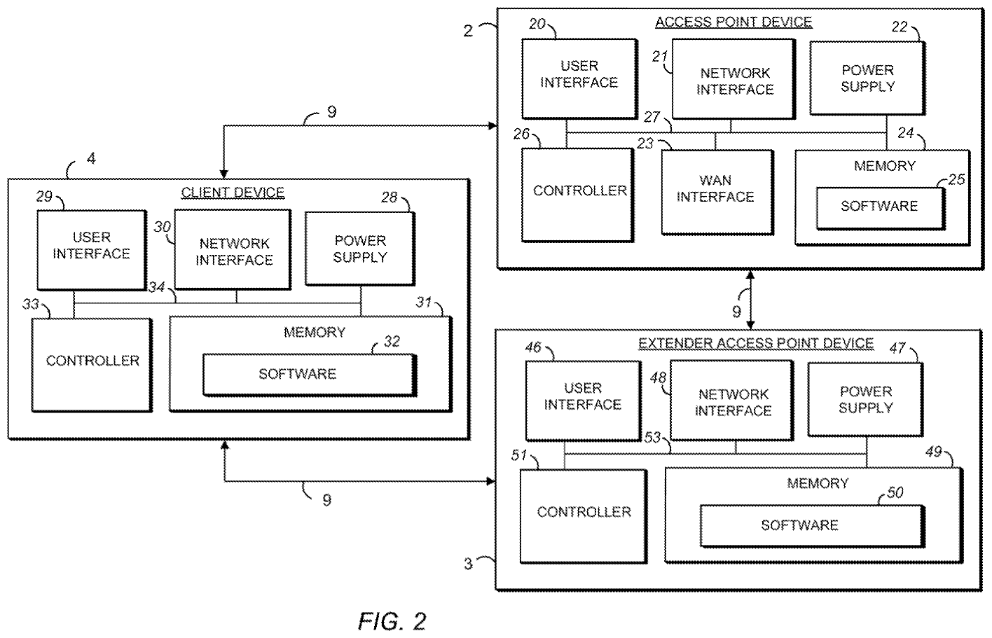

A detailed description of the exemplary internal components of the APD 2, the one or more EAPDs 3, and the one or more client devices 4 shown in FIG. 1 will be provided in the discussion of FIG. 2. However, in general, it is contemplated by the present disclosure that the APD 2, the one or more EAPD 3, and the one or more client devices 4 include electronic components or electronic computing devices operable to receive, transmit, process, store, and/or manage data and information associated with the network environment 150 and/or network system 100, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the APD 2, the one or more EAPDs 3, and the one or more client devices 4 may be adapted to execute any operating system, including Linux, UNIX, Windows, MacOS, DOS, and Chrome OS as well as virtual machines adapted to virtualize execution of a particular operating system, including customized and proprietary operating systems. The APD 2, the one or more EAPDs 3, and the one or more client devices 4 are further equipped with components to facilitate communication with other network devices over the one or more network connections to local and wide area networks, wireless and wired networks, public and private networks, and any other communication network enabling communication in the network environment 150 and/or network system 100.

FIG. 2 is a more detailed block diagram illustrating various components of an exemplary APD 2, a client device 4, and a EAPD 3 implemented in the network environment 150 of FIG. 1, according to some example embodiments.

Although FIG. 2 only shows one EAPD 3 and one client device 4, the EAPD 3 and the client device 4 shown in the figure are meant to be representative of the other EAPDs 3 and client devices 4 of a network system, for example, network system 100 shown in FIG. 1. Similarly, the connections 9 between the APD 2, the EAPD 3, and the client device 4 shown in FIG. 2 are meant to be exemplary connections and are not meant to indicate all possible connections between the APDs 2, EAPDs 3, and client devices 4. Additionally, it is contemplated by the present disclosure that the number of APDs 2, EAPDs 3, and client devices 4 is not limited to the number of APDs 2, EAPDs 3, and client devices 4 shown in FIGS. 1 and 2.

Now referring to FIG. 2, the client device 4 can be, for example, a computer, a portable device, an electronic tablet, an e-reader, a PDA, a mobile phone such as a smart phone, a smart speaker, an IoT device, an iControl device, portable music player with smart capabilities capable of connecting to the Internet, cellular networks, and interconnecting with other devices via Wi-Fi and Bluetooth, or other wireless hand-held consumer electronic device capable of receiving one or more configuration notifications from APD 2.

As shown in FIG. 2, the client device 4 includes a power supply 28, a user interface 29, a network interface 30, a memory 31, and a controller 33. The power supply 28 supplies power to the internal components of the client device 4 through the internal bus 34. The power supply 28 can be a self-contained power source such as a battery pack with an interface to be powered through an electrical charger connected to an outlet (for example, either directly or by way of another network device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the client device 4. The network interface 30 can include, but is not limited to, various network cards, interfaces, and circuitry implemented in software and/or hardware to enable communications with the APD 2 and the EAPD 3 using the communication protocols in accordance with connection 9 (for example, as described with reference to FIG. 1).

The memory 31 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, client device 4 is an electronic device, such as a mobile phone, and software 32 includes one or more instructions for establishing a FH connection with the APD 2.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure. Communication between the components (for example, 28-31 and 33) of the client device 4 may be established using an internal bus 34.

The EAPD 3 can be, for example, any wireless hardware electronic device used to extend a wireless network by receiving the signals transmitted by the APD 2 and rebroadcasting the signals to a client device 4, which may be out of range of the APD 2 including, but not limited to, a wireless extender, a repeater, and/or an access point. The EAPD 3 can also receive signals from any one or more of the client devices 4 and rebroadcast the signals to the APD 2, or any other one or more client devices 4.

As shown in FIG. 2, the EAPD 3 includes a user interface 46, a power supply 47, a network interface 48, a memory 49, and a controller 51. The user interface 46 can include, but is not limited to, push buttons, a keyboard, a keypad, an LCD, a TFT, an LED, an HD or other similar display device including a display device having touch screen capabilities so as to allow interaction between a user and the EAPD 3. The power supply 47 supplies power to the internal components of the EAPD 3 through the internal bus 53. The power supply 47 can be connected to an electrical outlet (for example, either directly or indirectly by way of another device) via a cable or wire.

The network interface 48 can include various network cards, interfaces, and circuitry implemented in software and/or hardware to enable communications with the client device 4 and the APD 2 using the communication protocols in accordance with connection 9 (for example, as described with reference to FIG. 1). For example, the network interface 48 can include multiple radios or sets of radios (for example, a 2.4 GHz radio, one or more 5 GHz radios, and/or a 6 GHz radio), which may also be referred to as wireless local area network (WLAN) interfaces. One radio or set of radios (for example, 5 GHz and/or 6 GHz radio(s)) provides a BH connection between the EAPD 3 and the APD 2, and optionally other EAPD(s) 3. Another radio or set of radios (for example, 2.4 GHz, 5 GHz, and/or 6 GHz radio(s)) provides a fronthaul (FH) connection between the EAPD 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the EAPD 3 in accordance with the embodiments described in the present disclosure.

The controller 51 controls the general operations of the EAPD 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software for controlling the operation and functions of the EAPD 3 in accordance with the embodiments described in the present disclosure. General communication between the components (for example, 46-49 and 51) of the EAPD 3 may be established using the internal bus 53.

The APD 2 can be, for example, a hardware electronic device that can combine one or more functions of any of a modem, a gateway, an access point (AP), a router, or combinations thereof for providing content received from the content provider (ISP) 1 to network or wireless devices (for example, EAPDs 3, client devices 4) in the network environment 150. It is also contemplated by the present disclosure that the APD 2 can include the function of, but is not limited to, an IP/QAM STB or SMD that is capable of decoding audio/video content, and playing OTT or MSO provided content. As shown in FIG. 2, the APD 2 includes a user interface 20, a network interface 21, a power supply 22, a wide area network (WAN) interface 23, a memory 24, and a controller 26. The user interface 20 can include, but is not limited to, push buttons, a keyboard, a keypad, an LCD, a TFT, an LED, an HD or other similar display device including a display device having touch screen capabilities so as to allow interaction between a user and the APD 2, for example, so as to provide one or more configuration notifications to a user.

The network interface 21 may include various network cards, and circuitry implemented in software and/or hardware to enable communications with the EAPD 3 and the client device 4 using the communication protocols in accordance with connection 9 (for example, as described with reference to FIG. 1). Additionally, the various network cards, interfaces, and circuitry of the network interface 21 enable communications with a client device 4 (for example, a mobile device) using the one or more communication protocols in accordance with connection 10 (for example, as described with reference to FIG. 1). For example, the network interface 21 can include an Ethernet port (also referred to as a LAN interface) and multiple radios or sets of radios (for example, a 2.4 GHz radio, one or more 5 GHz radios, a 6 GHz radio, and/or any other radio also referred to as WLAN interfaces). One radio (and/or set of radios) (for example, 5 GHz and/or 6 GHz radio(s)) provides a BH connection between the APD 2 and the EAPD(s) 3. Another radio (and/or set of radios) (for example, 2.4 GHz, 5 GHz, 6 GHz, and/or other radio(s)) provides a FH connection between the APD 2 and one or more client device(s) 4.

The power supply 22 supplies power to the internal components of the APD 2 through the internal bus 27. The power supply 22 can be connected to an electrical outlet (for example, either directly or by way of another device) via a cable or wire. The wide area network (WAN) interface 23 may include various network cards, and circuitry implemented in software and/or hardware to enable communications between the APD 2 and the ISP 1 using the wired and/or wireless protocols in accordance with connection 13 (for example, as described with reference to FIG. 1).

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for controlling the general functions and operations of the 2 and performing configuration and communication functions related to one or more network devices (network resource 8, EAPDs 3 and client devices 4) in the network in accordance with the embodiments described in the present disclosure.

The controller 26 controls the general operations of the APD 2 as well as performs configuration and connection functions related to one or more network devices (network resource 8, one or more EAPDs 3 and client device 4) in the network. The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of computer-readable instructions, algorithms, or software including the software 25 for controlling the operation and functions of the APD 2 in accordance with the embodiments described in the present disclosure. Communication between the components (for example, 20-24, and 26) of the APD 2 may be established using the internal bus 27. The controller 26 may also be referred to as a processor, generally.

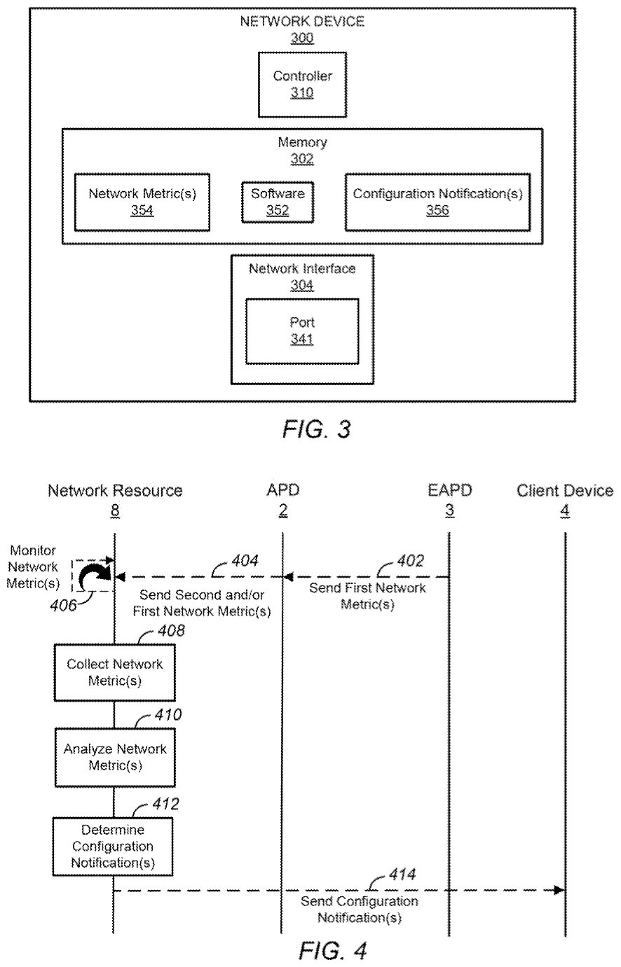

FIG. 3 is a more detailed block diagram illustrating certain components of an exemplary network device 300, for example, a network resource 8, according to one or more aspects of the present disclosure. As shown in FIG. 3, the network device 300 includes the network interface 304, for example, similar to or the same as network interface 21, the memory 302, for example, similar to or the same as network memory 24, and the controller (processor) 310, for example, similar to or the same as controller 26. The network interface 304 includes an Ethernet port 341 (for example, a wired LAN interface), a 2.4 GHz radio 343 (associated with a 2.4 GHz band), a 5 GHz radio 345 (associated with a 5 GHz band), a 6 GHz radio 347 (associated with a 6 GHz band), and/or any other radio associated with any other frequency band (for example, wireless LAN interfaces, or WLAN interfaces). The network device 300 may communicate with the local area network devices (for example, an APD 2, the one or more EAPDs 3 and/or the one or more client devices 4) of a system, for example, network environment 150 of FIG. 1, via one or more of the Ethernet port 341, and/or one or more radios. However, some other example embodiments of inventive concepts of the present disclosure are not limited to these interfaces only (for example, the techniques may be applied with a 6 GHz radio, higher frequency band radio and/or other similar future developed technologies). As mentioned above, according to aspects of the present disclosure, controller 310 analyzes one or more network metrics received from one or more network devices of the network environment 150 and determines one or more configuration notifications 356 based on the one or more network metrics and one or more corresponding thresholds.

The memory 302 stores one or more computer-readable instructions, for example, a software or application 352, one or more network metrics 354, one or more configuration notifications 356. The one or more network metrics 354 can comprise an uplink and/or downlink speed associated with a network device, for example, an APD 2 and/or an EAPD 3, in the network environment 150, client data consumption rate for one or more client devices associated with one or more network devices, for example, an APD 2 and/or an EAPD 3, in the network environment 150, or both. The software 352, for example, can determine that one or more configuration notifications 356 are associated with an analysis of the one or more network metrics 354. As an example, the analysis can make a comparison of one or more network metrics 354 averaged over a period of time to one or more corresponding thresholds. The one or more configuration notifications 356 can comprise information or a recommendation for improving one or more network metrics, such as any of replacing one or more existing or current network devices with one or more other network devices, adding one or more other network devices, removing one or more existing or current network devices, upgrading hardware, software, or both, or any combination thereof.

The controller 310 can be or include a processor that is configured to access the memory 302. If, for example, the network device 300 is a network resource 8, the controller 310 can execute one or more computer-readable instructions, such as software 352. The processor of the controller 310 also controls communications with the network or wireless devices (for example, the one or more EAPDs 3 and/or the one or more client devices 4) via network interface 304. In one or more embodiments, the controller 310 can execute software 352 to query for and/or receive the one or more network metrics 354, the one or more configuration notifications 356, or both from a remote resource and/or a remote repository (such as another network resource 8).

FIG. 4 is a flow diagram illustrating providing one or more configuration notifications to a client device 4, for example, a client device 4E associated with a user 110, according to one or more embodiments. The network resource 8 may be programmed with one or more instructions (for example, one or more computer-readable instructions) to perform the configuration of the APD 2 according to one or more embodiments, or may use its native software in some other example embodiments. In FIG. 4, it is assumed that the network devices include their respective controllers and their respective software stored in their respective memories, as discussed above in connection with FIGS. 1-3, which when executed by their respective controllers perform the functions and operations in accordance with the example embodiments of the present disclosure.

The network resource 8 comprises a controller 310 that executes one or more computer-readable instructions, stored on a memory 302, that when executed perform one or more of the operations. In one or more embodiments, the one or more instructions can be one or more software applications, for example, one or more software 352. While the operations are presented in a certain order, the present disclosure contemplates that any one or more operations can be performed simultaneously, substantially simultaneously, repeatedly, in any order or not at all (omitted).

A network environment 150 can comprise any of an APD 2, an EAPD 3, one or more client devices 4, or any combination thereof. The client device 4 can be within the network environment 150 or remote from the network environment 150. For example, the network environment 150 can store one or more user identifiers that comprise an identifier associated with user, a user account associated with the network environment (for example, a customer of an ISP), a client device associated with a user and/or a user account, any other identifier associated with the user and/or the client device, or any combination thereof. For example, the user identifier can comprise an email address associated with the user and/or any other unique identifier associated with a user. The network resource 8 can collect one or more network metrics from one or more network devices in the network environment 150. For example, an EAPD 3 can send one or more first network metrics associated with the EAPD 3 at 402 to an APD 2. The APD 2 can send the one or more first network metrics from 402, one or more second network metrics associated with the APD 2, or both at 404 to the network resource 8. While FIG. 4 illustrates one or more first network metrics associated with an EAPD 3 and one or more second network metrics associated with an APD 2, the present disclosure contemplates and number of one or more network metrics associated with any one or more network devices.

The network resource 8 can monitor for one or more network metrics at 406, for example, the one or more second network metrics, the one or more first network metrics, or both. The network resource 8 can monitor for the one or more network metrics for a period of time. For example, the network resource 8 can monitor at one or more times of a day, one or more days of a week or month, any other interval or periodicity, or any combination thereof. For example, the network resource 8 can monitor for one or more network metrics based on historical data that indicates high network usage, low network usage, or both, one or more predetermined time indicators set by a user, any other basis, or any combination thereof. In one or more embodiments, the network resource 8 monitors for the one or more network metrics any of periodically, constantly, automatically, on-command or on-demand, by request, or any combination thereof.

The one or more first network metrics and/or one or more second network metrics can comprise any of data uplink speed, data downlink speed, data consumption, or any combination thereof. For example, the data uplink speed and/or data downlink speed can comprise data or information from a speed test which can be triggered from a client device associated with a user that has a connection to one or more network devices of the network environment 150, such as an APD 2 and/or an EAPD 3. The data consumption can be associated with one or more radios of one or more network devices, such as bytes sent, bytes received, or both for a radio associated with a network device.

At 408, the network resource 8 collects one or more network metrics, such as one or more first network metrics, one or more second network metrics, or both. The collecting the one or more network metrics can comprise any of storing the one or more network metrics in a memory local to (such as a memory 302), remote from (such as any of a cloud server, a web site, a repository, a network service, any other network device capable of storing one or more network metrics, or any combination thereof), organizing the one or more network metrics, for example, based on an associated network device, any other collection, or any combination thereof.

The network resource 8 at 410 can analyze the one or more network metrics received and/or collected. The network resource 8 can, for example, average the one or more network metrics associated with a network device. As an example, the network resource 8 can determine the one or more network metrics associated with a network that were received or collected during a period of time and average those one or more network metrics. For example, the network resource 8 can receive for a period of time (such as thirty minutes, one hour, or any other period of time) one or more BytesSent and/or BytesReceived associated with a network device as the one or more network metrics and can average these one or more network metrics. The network resource 8 can then compare the average to a corresponding network metric threshold.

At 412, based on the comparison of the average to a corresponding network metric threshold, the network resource 8, can determine one or more configuration notifications. The one or more configuration notifications can comprise information or recommendations for replacement of one or more existing or current network devices with one or more different network devices, for example, to upgrade the network environment 150. As an example, uplink/downlink speed associated with a network device can be received as one or more network metrics over a period of time. A corresponding uplink/downlink speed threshold can be set to 570 megabits per second (Mbps) for a 2G radio and 1200 Mbps for a 5G radio. If a comparison indicates that the averaged uplink/downlink speed is at, above, or a percentage of (such as 80%) the corresponding uplink/downlink speed threshold, then the network resource 8 can determine one or more configuration notifications based on the comparison. Similarly, a corresponding throughput threshold can be set to 570 Mbps for a 2G radio and 1200 Mbps for a 5G radio. If a comparison indicates that the averages consumption BytesSent and BytesReceived is at, above or a percentage of (such as 80%) the corresponding throughput threshold, then the network resource 8 can determine one or more configuration notifications based on the comparison. The determining the one or more configuration notification can be based on any of the comparison, one or more network devices associated with the one or more network metrics, a user identifier (such as a user account associated with the network environment), or any combination thereof.

At 414, the network resource 8 sends on or more configuration notifications to a client device 4 that is local to or remote from a network environment 150. For example, the network resource 8 can determine a user associated with the network environment 150 and/or one or more network devices and can send the one or more configuration notifications to the user and/or a client device 4 associated with the user, such as via an electronic message (for example, email, text message, any other messaging, or any combination thereof), a user interface (for example, an application running on the client device, such as a mobile phone), any other communication service or method, or any combination thereof. The one or more configuration notifications can comprise information or a recommendation to the user that one or more network metrics can be improved by any of replacing one or more existing or current network devices with one or more other network devices, adding one or more other network devices, removing one or more existing or current network devices, upgrading hardware, software, or both, or any combination thereof. As an example, The one or more existing or current network devices can be the one or more network devices that sent one or more network metrics or one or more different network devices. The one or more other network devices can be a different model of the one or more existing or current network devices.

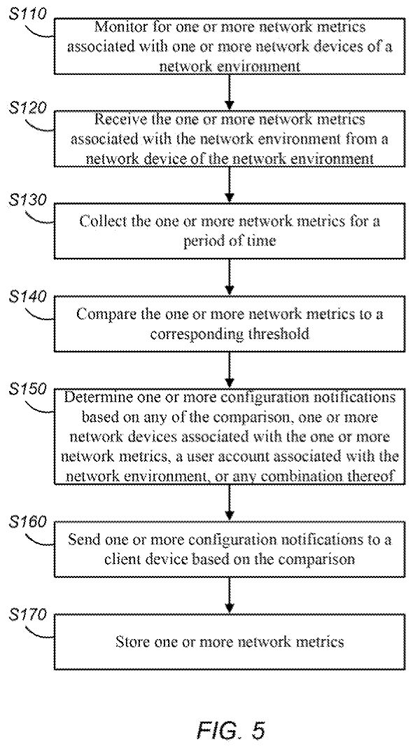

FIG. 5 is a flow chart illustrating a method for providing one or more configuration notifications to a client device, according to one or more aspects of the present disclosure.

In one or more embodiments, a network resource may be a network device that includes a controller 310 that may be programmed with or to execute one or more instructions (for example, software or application 352) to perform steps for determining one or more configuration notifications associated with a network environment 150. In FIG. 5, it is assumed that the network devices include their respective controllers and their respective software stored in their respective memories, as discussed above in reference to FIGS. 1-4, which when executed by their respective controllers perform the functions and operations in accordance with the example embodiments of the present disclosure.

The controller 310 executes one or more computer-readable instructions, stored in a memory, for example, a memory 302 of a network resource 8 that when executed perform one or more of the operations of steps S110-S170. In one or more embodiments, the one or more instructions may be one or more software applications, for example, a software 352 of a network resource 8. While the steps S110-S170 are presented in a certain order, the present disclosure contemplates that any one or more steps can be performed simultaneously, substantially simultaneously, repeatedly, in any order or not at all (omitted).

At step S110, the network resource 8 monitors for one or more network metrics associated with one or more network devices of a network environment, such as a network environment 150 of FIG. 1. The network resource 8 can monitor for a period of time so as to be able to perform an average of the one or more network metrics. The one or more network metrics comprise any of an uplink speed, a downlink speed, a client data consumption rate, or any combination thereof.

At step S120, the network resource 8 receives one or more network metrics associated with the network environment from a network device of the network environment. In one or more embodiments, the network resource 8 receives one or more first network metrics associated with a first network device (such as an EAPD 3) and one or more second network metrics associated with a second network device (such as an APD 2).

At step S130, the network resource 8 can collect the one or more network metrics for a period of time. For example, the network resource 8 can any of poll, pull, query, request, or any combination thereof for and/or pull one or more network metrics from one or more network devices of a network environment. For example, an APD 2 of a network environment 150 can receive a query from the network resource 8 and can respond with any of one or more second network metrics associated with the APD 2, one or more first network metrics associated with one or more EAPDs 3, or both.

At step S140, the network resource 8 can compare the one or more network metrics to a corresponding threshold. The comparison can be based on an average of the one or more network metrics collected for a period of time. The average can then be compared to the corresponding threshold.

At step S150, the network resource 8 can determine one or more configuration notifications based on any of the comparison, one or more network devices associated with the one or more network metrics, a user account associated with the network environment, or any combination thereof. In one or more embodiments, the network resource 8 can query any of a memory (local to and/or remote from the network resource 8), a repository, another network resource 8, a website, a cloud server, a service, or any combination for the one or more configuration notifications associated with one or more network metrics. For example, a network device manufacturer can maintain a repository of information associated with each network device offered by the manufacturer. The network resource 8 can query this repository for any of one or more network devices, software, hardware, or any combination thereof that can be used to improve a network environment based on one or more network issues. The network resource 8 can receive the information from the query and based on the information determine one or more configuration notifications. In one or more embodiments, the network resource 8 can receive in response to the query the one or more configuration notifications.

At step S160, the network resource 8 sends one or more configuration notifications to a client device based on the comparison from step S140. The one or more network configurations comprise a recommendation for any of replacing one or more existing or current network devices with one or more other network devices, adding one or more other network devices, removing one or more existing or current network devices, upgrading hardware, software, or both, or any combination thereof. In one or more embodiments, the client device is associated with a user account associated with the network environment. For example, the network resource 8 can identify a user associated with the network environment and can based on the identification determine the client device that is to receive the one or more network configurations. In one or more embodiments, the client device can comprise an application that runs on a network device such as mobile phone, a tablet, or any other network device associated with a user.

At step S170, the network resource 8 can store the one or more network metrics locally or remotely from the network resource 8 for use as historical data or for use with respect to any one or more steps of FIG. 5.

According to one or more example embodiments of inventive concepts disclosed herein, there are provided novel solutions for improving a network environment by a network resource providing one or more configuration notifications to a user, for example, associated with a client device, for changing or otherwise altering the network environment, such as by any of replacing, adding, removing, or otherwise updating or upgrading hardware and/or software associated with one or more network devices of the network environment. In this way, the user is informed of new or upgraded network devices that will improve one or more network metrics associated with one or more network devices of the network environment.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A network resource for determining one or more configuration notifications, the network resource comprising:
a memory storing one or more computer-readable instructions;
a processor configured to execute the one or more computer-readable instructions stored on the memory to cause the network resource to:
receive one or more network metrics associated with a network environment from a network device of the network environment;
compare the one or more network metrics to a corresponding threshold; and
send one or more configuration notifications to a client device based on the comparison.

2. The network resource of claim 1, wherein the processor is further configured to execute the one or more computer-readable instructions to cause the network resource to:
collect the one or more network metrics for a period of time; and
wherein the comparing the one or more network metrics comprises averaging the one or more network metrics collected for a period of time and comparing the average to the corresponding threshold.

3. The network resource of claim 1, wherein at least one of:
the one or more network metrics comprise any of an uplink speed, a downlink speed, a client data consumption rate, or any combination thereof; and
the one or more network metrics comprises one or more first network metrics associated with another network device and one or more second network metrics associated with the network device.

4. The network resource of claim 1, wherein the processor is further configured to execute the one or more computer-readable instructions to cause the network resource to:
store the one or more network metrics.

5. The network resource of claim 1, wherein the one or more network configurations comprise a recommendation for any of replacing one or more existing or current network devices with one or more other network devices, adding one or more other network devices, removing one or more existing or current network devices, upgrading hardware, software, or both, or any combination thereof.

6. The network resource of claim 1, wherein the processor is further configured to execute the one or more computer-readable instructions to cause the network resource to:
determine one or more configuration notifications based on any of the comparison, one or more network devices associated with the one or more network metrics, a user account associated with the network environment, or any combination thereof.

7. The network resource of claim 1, wherein the client device is associated with a user account associated with the network environment.

8. A method for a network resource for determining one or more configuration notifications, the method comprising:
receiving one or more network metrics associated with a network environment from a network device of the network environment;
comparing the one or more network metrics to a corresponding threshold; and
sending one or more configuration notifications to a client device based on the comparison.

9. The method of claim 8, further comprising:
collecting the one or more network metrics for a period of time; and
wherein the comparing the one or more network metrics comprises averaging the one or more network metrics collected for a period of time and comparing the average to the corresponding threshold.

10. The method of claim 8, wherein at least one of:
the one or more network metrics comprises one or more first network metrics associated with another network device and one or more second network metrics associated with the network device; and
the one or more network metrics comprise any of an uplink speed, a downlink speed, a client data consumption rate, or any combination thereof.

11. The method of claim 8, further comprising:
storing the one or more network metrics.

12. The method of claim 8, wherein the one or more network configurations comprise a recommendation for any of replacing one or more existing or current network devices with one or more other network devices, adding one or more other network devices, removing one or more existing or current network devices, upgrading hardware, software, or both, or any combination thereof.

13. The method of claim 8, further comprising:
determining one or more configuration notifications based on any of the comparison, one or more network devices associated with the one or more network metrics, a user account associated with the network environment, or any combination thereof.

14. The method of claim 8, wherein the client device is associated with a user account associated with the network environment.

15. A non-transitory, computer-readable medium storing one or more computer-readable instructions for a network resource, that when executed by a processor, cause the processor to perform one or more operations comprising:
receiving one or more network metrics associated with a network environment from a network device of the network environment;
comparing the one or more network metrics to a corresponding threshold; and
sending one or more configuration notifications to a client device based on the comparison.

16. The non-transitory, computer-readable medium of claim 15, wherein the one or more computer-readable instructions when executed by the processor, further cause the processor to perform the one or more operations further comprising:
collecting the one or more network metrics for a period of time; and
wherein the comparing the one or more network metrics comprises averaging the one or more network metrics collected for a period of time and comparing the average to the corresponding threshold.

17. The non-transitory, computer-readable medium of claim 1, wherein at least one of:
the one or more network metrics comprises one or more first network metrics associated with another network device and one or more second network metrics associated with the network device;
the one or more network metrics comprise any of an uplink speed, a downlink speed, a client data consumption rate, or any combination thereof; and
the one or more network configurations comprise a recommendation for any of replacing one or more existing or current network devices with one or more other network devices, adding one or more other network devices, removing one or more existing or current network devices, upgrading hardware, software, or both, or any combination thereof.

18. The non-transitory, computer-readable medium of claim 15, wherein the client device is associated with a user account associated with the network environment.

19. The non-transitory, computer-readable medium of claim 15, wherein the client device is associated with a user account associated with the network environment.

20. The non-transitory, computer-readable medium of claim 15, wherein the one or more computer-readable instructions when executed by the processor, further cause the processor to perform the one or more operations further comprising at least one of:
storing the one or more network metrics.
